(19) United States
(12) Patent Application Publication
(10) Pub. No.: US 2026/0194130 A1
(43) Pub. Date: Jul. 9, 2026

(54) Suspended Ball Screw Vehicle Body Extension Mech

(71) Applicant: Xinfang Zhang, Shanxi (CN)

(72) Inventor: Xinfang Zhang, Shanxi (CN)

(21) Appl. No.: 19/009,335

(22) Filed: Jan. 3, 2025

(51) Int. Cl. F16H 25/22; B62D 21/14; F16H 25/20

(52) U.S. Cl. CPC F16H 25/2214; B62D 21/14; F16H 2025/2096

(57) ABSTRACT

This application involves a suspended ball screw vehicle box extension mechanism, including an extendable box, a load-bearing plate, a carrying box, a support frame, a modular guide assembly, and a ball screw drive assembly. The extendable box is set at the opening of the vehicle body, with corresponding carrying boxes below the relative side walls. The load-bearing plate is fixed on the carrying box, the modular guide assembly is fixed on one side to the support frame and on the other side to the load-bearing plate, and the ball screw drive assembly is fixed to the support frame and load-bearing plate. The carrying box has a long slot at the bottom, allowing it to slide along the lower end of the support frame. This application can achieve the extension and retraction of the vehicle body, increasing the usable space within the vehicle.

### TECHNICAL FIELD

This invention relates to the field of vehicle interior space expansion technology, particularly to a suspended ball screw vehicle box extension mechanism.

### BACKGROUND OF THE INVENTION

Existing vehicles and recreational vehicles RVs are equipped with extendable boxes to increase internal usable space. The outer walls of these extendable boxes align with the exterior of the vehicle or trailer during travel, and when the vehicle stops, the box is extended outward from the vehicle's opening to increase internal use space.

Patent No. CN202111541306.4 discloses an RV extension mechanism where the sliding mechanism is located below and on the sides of the vehicle body, lacking integrated design, occupying significant space, being inconvenient for installation, and operating unstably.

Patent No. US202117408020A describes a sliding device set on both sides of the extendable box. Due to the complexity of the used mechanisms, the telescopic drive device is too high, occupies considerable space, is inconvenient for maintenance, and increases usage costs.

Regarding the aforementioned technologies, the inventor believes that the sliding mechanism of vehicle box extension systems is relatively large, complex to install, and costly. Therefore, it is considered that the sliding mechanism of vehicle extendable boxes has the issue of occupying substantial space.

### SUMMARY OF THE INVENTION

To address the problem of the sliding mechanism of vehicle extendable boxes occupying significant space, this invention provides a suspended ball screw vehicle box extension system. It can increase vehicle usage space, improve spatial utilization, and since the entire sliding mechanism inside the carrying box is integrally connected to the support frame base plate, there is no need to dismantle the lower chassis of the vehicle body. Installation and removal are convenient; simply fix the support frame's base plate to the vehicle body, allowing the entire extendable box to be placed at the vehicle's opening.

### DETAILED DESCRIPTION OF THE PREFERRED EMBODIMENTS

To achieve the above objectives, this invention adopts the following technical solution:
A suspended ball screw vehicle box extension system includes an extendable box, a carrying box, a support frame, a modular guide rail assembly, a ball screw drive assembly, and a load-bearing plate. The extendable box is set at the opening of the vehicle body. One side of the modular guide rail assembly is fixed on the support frame, while the other side is fixed on the load-bearing plate, which is attached to the carrying box. The ball screw drive assembly is fixed on the support frame and the load-bearing plate. The modular guide rail assembly, the ball screw drive assembly, the load-bearing plate, and part of the support frame (excluding the base plate) are integrally set inside the carrying box. The carrying box is symmetrically arranged on both sides below the extendable box, with a long slot opening at its bottom. The carrying box slides back and forth along the lower end of the support frame through this long slot opening.

Through the adoption of the above technical solutions, the ball screw drive assembly can cause the modular guide rail assembly to slide back and forth, thereby enabling the carrying box to slide back and forth, achieving the extension and retraction of the extendable box. The integration of the modular guide rail assembly, the ball screw drive assembly, the load-bearing plate, and part of the support frame (excluding the base plate) inside the carrying box isolates external influences, facilitates installation and removal, maintains an aesthetic appearance, and increases the internal usable space of the vehicle. The long slot opening at the bottom of the carrying box slides out and retracts from the lower end of the support frame, with the base plate supporting the entire extendable box. There is no need to disassemble the vehicle chassis; simply fixing the support frame's base plate to the vehicle body allows the entire extendable box to be suspended at the vehicle's opening, transmitting the weight of the extendable box to the vehicle body via the support frame.

The support frame includes an upper plate, a lower plate, and a base plate, with the base plate fixed to the vehicle body. Through the above technical solution, the weight supported by the support frame can be transmitted to the vehicle body via the base plate.

The modular guide rail assembly comprises rail one, rail two, slider one, slider two, slider three, and slider four. Rail one and rail two are parallelly mounted on the carrying box through the load-bearing plate. Slider one and slider three are slidably connected to rail one, while slider two and slider four are slidably connected to rail two. Slider one and slider three are fixed on the lower plate, and slider two and slider four are fixed on the upper plate. Through the above technical solution, friction between rail one and rail two during reciprocating motion is reduced, and the load-bearing plate can facilitate the extension and retraction of the carrying box and extendable box. Additionally, the weight of the carrying box can be transferred to the rails through the load-bearing plate, then to the sliders, and finally to the support frame.

Rail one and rail two maintain a cantilever setting when extending and retracting the extendable box through fixed sliders one, two, three, and four. Through the above technical solution, the cantilever structure formed by rail one through sliders one and three, and rail two through sliders two and four, increases the extension length of the extendable box, enhancing internal use space without requiring additional support.

Sliders one and two are vertically aligned, as are sliders three and four, and sliders one and three are in a straight line, parallel to sliders two and four. Through the above technical solution, when rail one and rail two slide back and forth, force distribution is balanced, operation is stable, and friction is minimized.

The ball screw drive assembly includes a motor, motor bracket, small synchronous pulley, ball screw, nut flange, cover, bearing one, bearing two, nut flange sleeve, large synchronous pulley, synchronous belt, and nut mounting bracket. The motor is fixed on the upper plate via the motor bracket, with its output shaft connected to the small synchronous pulley. The ball screw passes through the nut flange, which has a large synchronous pulley mounted on the nut flange sleeve. The small synchronous pulley and the large synchronous pulley are synchronously connected by the synchronous belt. Bearing one is set on the cover, and bearing two is set on the nut flange sleeve. The nut flange, cover, nut flange sleeve, bearing one, and bearing two are all fixed on the support frame via the nut mounting bracket. Through the above technical solution, the motor drives the small synchronous pulley to rotate, which in turn rotates the large synchronous pulley via the synchronous belt, causing the nut flange to rotate. The nut flange drives the ball screw to convert rotary motion into linear motion, thereby moving the carrying box and load-bearing plate together with rail one and rail two for extension and retraction.

The nut mounting bracket has bearing mounts one and two on either side to stabilize bearing one and bearing two. Through the above technical solution, it ensures bearings operate smoothly without oscillation.

The load-bearing plate has screw rod mounting brackets one and two at both ends, with the ball screw fixed to the load-bearing plate via these mounting brackets. Through the above technical solution, the load-bearing plate supports the ball screw and ensures the center axis of the ball screw remains straight. Additionally, rotation of the ball screw can drive the movement of the load-bearing plate.

The load-bearing plate, carrying box, and ball screw are parallel along their length. Through the above technical solution, when the ball screw drives the load-bearing plate to move, thus driving the carrying box to slide back and forth, it ensures balanced force distribution during motion, smooth operation, and minimal friction.

The carrying box has a removable inspection panel near the inside of the vehicle cabin. Through the above technical solution, it facilitates installation and allows for maintenance by removing the inspection panel if faults occur inside the carrying box, reducing maintenance costs.

In summary, this application includes at least one of the following beneficial technical effects:
1. The integration of the modular guide rail assembly, ball screw drive assembly, load-bearing plate, and part of the support frame (excluding the base plate) within the carrying box isolates external influences, facilitates installation and removal, maintains an aesthetic appearance, and increases the internal usable space of the vehicle.
2. Since the entire sliding mechanism inside the carrying box is integrally connected to the support frame base plate, there is no need to dismantle the lower chassis of the vehicle body. Installation and removal are convenient; simply fix the support frame's base plate to the vehicle body, allowing the entire extendable box to be placed at the vehicle's opening. The support frame transmits the weight of the extendable box to the vehicle body.
3. The inspection panel on the carrying box is removable, allowing for maintenance by removing the inspection panel if faults occur inside the carrying box, reducing maintenance costs.

### BRIEF DESCRIPTION OF THE DRAWINGS

To clearly explain the technical solutions of this invention, the drawings used in the description will be briefly introduced. It should be understood that the figures described below are merely some embodiments of this invention. Based on these drawings, those skilled in the art can obtain other drawings without creative work.

FIG. 1 shows a perspective view of the extendable box sliding out from the vehicle's opening in a specific embodiment of this invention.

FIG. 2 shows a perspective view of the extendable box fully retracted into the vehicle's opening in a specific embodiment of this invention.

FIG. 3 shows a front sectional view of the extendable box in a specific embodiment of this invention.

FIG. 4 shows a schematic diagram of the sliding mechanism in a specific embodiment of this invention.

FIG. 5 shows an exploded view of the sliding mechanism in a specific embodiment of this invention.

FIG. 6 shows a sectional view of the carrying box when the extendable box is fully extended in a specific embodiment of this invention.

FIG. 7 shows a sectional view of the carrying box when the extendable box is fully retracted in a specific embodiment of this invention.

FIG. 8, in which 8A shows an oblique view of the extendable box extended; 8B shows a side view of the extendable box extended; 8C shows a sectional view of the extendable box after the extendable box is extended.

FIG. 9, in which 9A shows an oblique view of the extendable box retracted; 9B is a side view of the extendable box retracted; 9C is a sectional view of the extendable box after the extendable box is retracted.

### BRIEF DESCRIPTION OF THE FIGURES

Follow are the reference numbers appear in the drawings:
1. Extendable box
2. Carrying box; 203. Inspection panel
3. Support frame; 3a. Upper plate; 3b. Lower plate; 3c. Base plate; 30. Modular guide rail assembly
4. Ball screw
5. Nut mounting bracket
6a. Rail one; 6b. Rail two
7. Load-bearing plate; 7a. Screw rod mounting bracket one; 7b. Screw rod mounting bracket two
8a. Slider one; 8b. Slider two; 8c. Slider three; 8d. Slider four
9. Long slot opening; 9a. Bearing mount one; 9b. Bearing mount two
10a. Bearing one; 10b. Bearing two
11. Nut flange sleeve
12. Large synchronous pulley
13. Nut flange
14. Cover
15. Synchronous belt
16. Small synchronous pulley
17. Motor bracket
18. Motor
25. Vehicle body
34. Ball screw drive assembly

### DETAILED DESCRIPTION OF THE INVENTION

To make the purpose, features, and advantages of this invention more apparent and understandable, the following detailed description of the technical solutions of this invention will be provided in conjunction with the accompanying drawings, illustrating only some of the embodiments of this invention. Based on the embodiments of this patent, those skilled in the art can obtain other embodiments without making any creative effort, all of which fall within the scope protected by this patent.

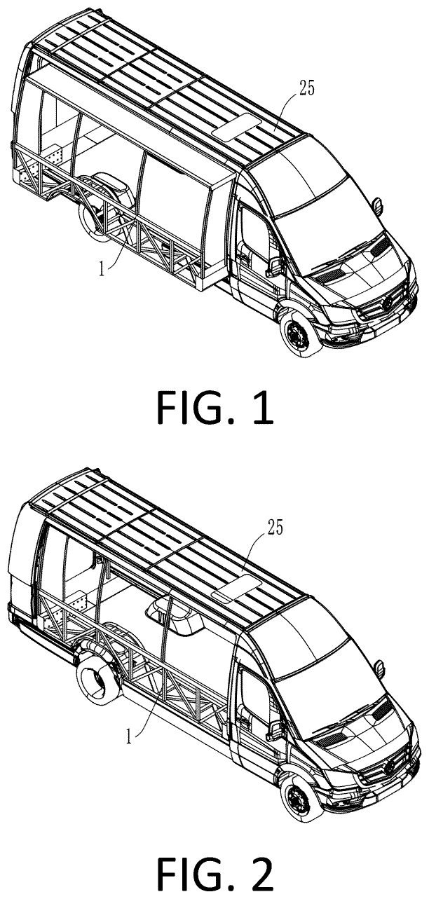

Referring to FIGS. 1 and 2, the extendable box 1 is set at the opening of the vehicle body 25. When the vehicle is stationary, the extendable box 1 completely slides out from the opening of the vehicle body 25, increasing the internal use space of the vehicle. After retraction, the extendable box 1 aligns with the exterior of the vehicle body 25, maintaining the overall aesthetic appearance.

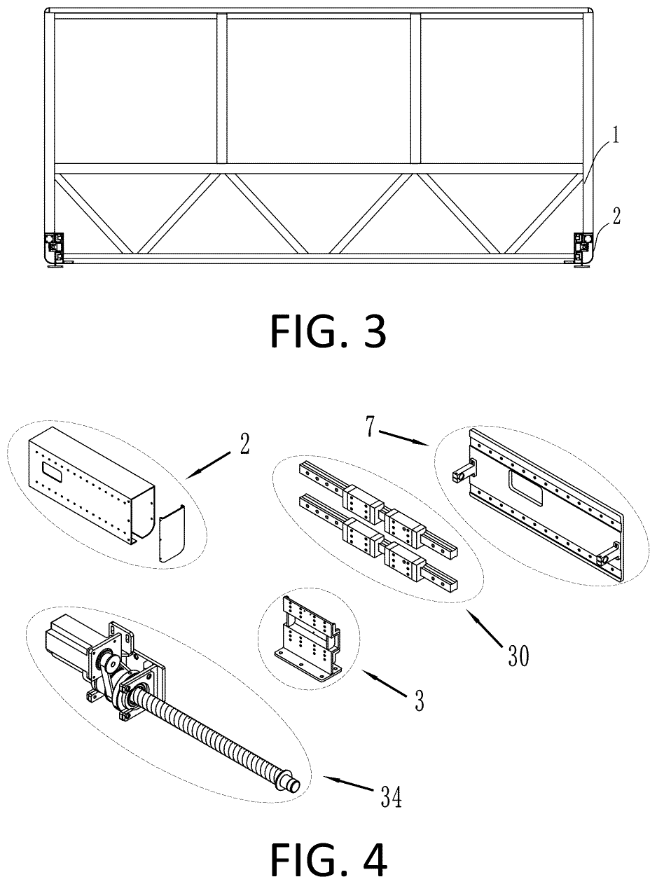

Referring to FIGS. 3 and 4, a suspended ball screw vehicle box extension mechanism includes an extendable box 1, a carrying box 2, a support frame 3, a modular guide assembly 30, a ball screw drive assembly 34, and a load-bearing plate 7. The extendable box 1 is made of aluminum alloy or other lightweight materials with high structural rigidity. Below the side walls of the extendable box 1, there are corresponding carrying boxes 2 on both sides, which have identical internal structures, are symmetrically arranged, and move synchronously, supporting the weight of the extendable box 1. The modular guide assembly 30, ball screw drive assembly 34, load-bearing plate 7, and part of the support frame 3 (excluding the base plate) are integrated within the carrying box 2, saving space and allowing for quick installation and removal.

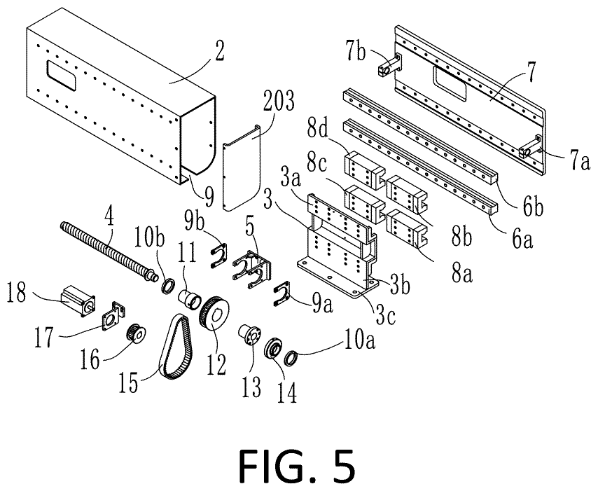

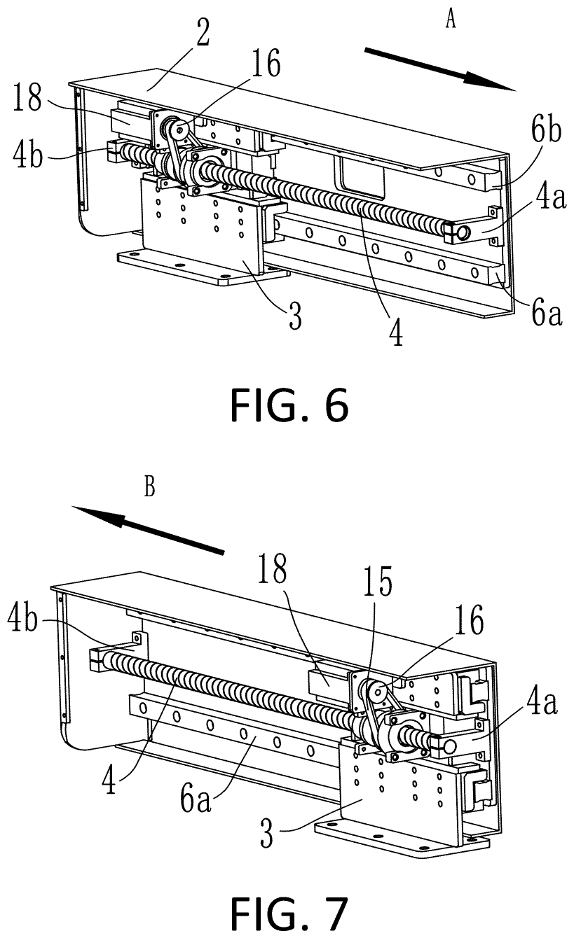

Referring to FIGS. 5, 6, and 7, the modular guide assembly 30 comprises rail one 6a, rail two 6b, slider one 8a, slider two 8b, slider three 8c, and slider four 8d. Rails one 6a and two 6b are mounted parallelly up and down via the load-bearing plate 7 inside the carrying box 2. Sliders one 8a and three 8c are connected slidingly to guide rail one 6a, while sliders two 8b and four 8d are connected slidingly to rail two 6b. The support frame 3 consists of upper plate 3a, lower plate 3b, and base plate 3c. Sliders one 8a and three 8c are fixed to the lower plate 3b, while sliders two 8b and four 8d are fixed to the upper plate 3a, with the base plate 3c being fixed to the vehicle body 25. Sliders one 8a and two 8b are vertically aligned, as are sliders three 8c and four 8d, and sliders one 8a and three 8c are in a straight line, parallel to sliders two 8b and four 8d. During the extension and retraction of the extendable box 1, guide rail one 6a remains suspended by sliders one 8a and three 8c, and rail two 6b by sliders two 8b and four 8d.

The ball screw drive assembly 34 includes a motor 18, motor bracket 17, small synchronous pulley 16, ball screw 4, nut flange 13, cover 14, bearing one 10a, bearing two 10b, nut flange sleeve 11, large synchronous pulley 12, synchronous belt 15, and nut mounting bracket 5. The motor 18 is mounted on the upper plate 3a via the motor bracket 17, with its output shaft connected to the small synchronous pulley 16. The ball screw 4 passes through the nut flange 13, which has the large synchronous pulley 12 attached. The small synchronous pulley 16 and large synchronous pulley 12 are synchronized via the synchronous belt 15. On either side of the nut flange 13, there are nut cover 14 and nut sleeve 11, with bearings one 10a and two 10b ensuring the rotational movement of the nut flange 13. These components are secured to the support frame 3 via the nut mounting bracket 5. The nut mounting bracket 5 also features bearing mounts one 9a and two 9b to stabilize bearings one 10a and two 10b. At each end of the load-bearing plate 7, there are screw rod mounting brackets one 7a and two 7b, fixing the ends of the ball screw 4 to the load-bearing plate 7.

The carrying box 2 has a removable inspection panel 203 on the side facing the interior of the vehicle, allowing for easy access for installation and maintenance. The bottom of the carrying box 2 has a long slot 9 that allows it to slide along the sides of the support frame 3.

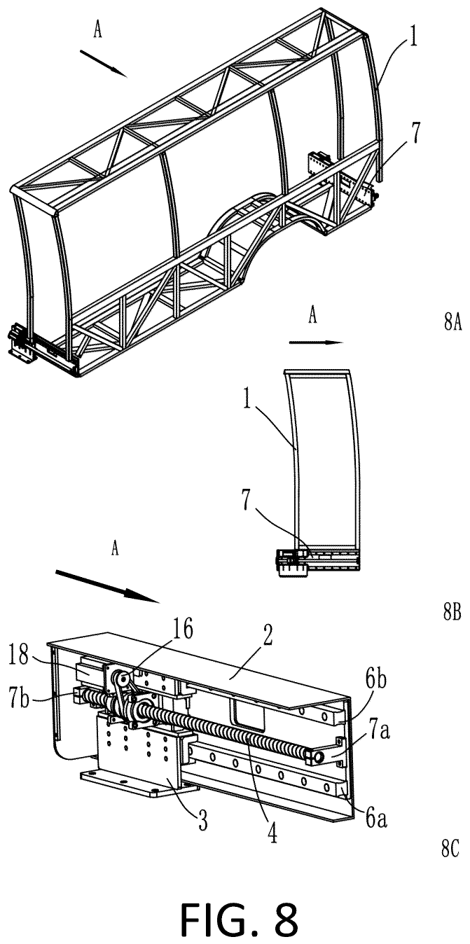

Referring to FIG. 8, during the extension of the suspended ball screw vehicle box extension mechanism, the motor 18 rotates the small synchronous pulley 16, which synchronizes with the large synchronous pulley 12 via the synchronous belt 15, causing the nut flange 13 to rotate. The nut flange 13 drives the ball screw 4, converting rotary motion into linear motion, thereby moving the carrying box 2 and load-bearing plate 7 outward along guide rails one 6a and two 6b. When the extendable box reaches the preset length, the extension process is complete. Throughout this process, the support frame 3 remains stationary. After the extendable box 1 extends, the carrying box 2 transfers its weight to the load-bearing plate 7, which then distributes the load through guide rails one 6a and two 6b to sliders one 8a, two 8b, three 8c, and four 8d, ultimately transferring the load to the support frame 3, which finally transfers it to the vehicle body 25.

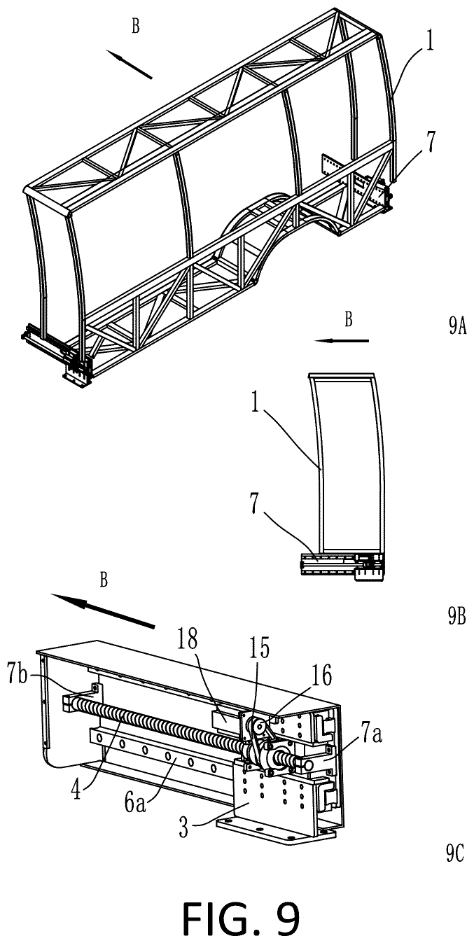

Referring to FIG. 9, during the retraction of the suspended ball screw vehicle box extension mechanism, the motor 18 rotates the small synchronous pulley 16 in reverse, which synchronizes with the large synchronous pulley 12 in reverse via the synchronous belt 15, causing the nut flange 13 to rotate in reverse. The nut flange 13 drives the ball screw 4, converting rotary motion into linear motion, thereby moving the carrying box 2 and load-bearing plate 7 inward along guide rails one 6a and two 6b. When the extendable box 1 aligns with the exterior of the vehicle body 25, the retraction process is complete.

The above description of the disclosed embodiment enables those skilled in the art to realize or use the present invention. Various modifications to these embodiments will be readily apparent to those skilled in the art, and the general principles defined herein may be implemented in other embodiments without departing from the spirit or scope of the invention. Therefore, the invention should not be limited to the embodiments shown herein but must be accorded the widest scope consistent with the principles and novel features disclosed herein.

1. A suspended ball screw vehicle box extension mechanism comprising an extendable box, a carrying box, a support frame, a modular guide assembly, a ball screw drive assembly, and a load-bearing plate. Said extendable box is positioned at the opening of the vehicle body, with the modular guide assembly fixed on one side to the support frame and on the other side to the load-bearing plate. The load-bearing plate is fixed on the carrying box, and the ball screw drive assembly is fixed on the support frame and the load-bearing plate. The modular guide assembly, ball screw drive assembly, load-bearing plate, and part of the support frame (excluding the base plate) are integrated within the carrying box, which is symmetrically placed under the two sides of the extendable box. The carrying box has a long slot at the bottom, through which it slides along the lower end of the support frame.

2. According to claim 1, the support frame comprises an upper plate, a lower plate, and a base plate, wherein the base plate is fixed on the vehicle body.

3. According to claim 2, the modular guide assembly comprises guide rail one, rail two, slider one, slider two, slider three, and slider four. Guide rails one and two are mounted parallelly up and down via the load-bearing plate inside the carrying box. Sliders one and three are connected slidingly to guide rail one, and sliders two and four are connected slidingly to rail two. Sliders one and three are fixed to the lower plate, and sliders two and four are fixed to the upper plate.

4. According to claim 3, guide rails one and two maintain a cantilever setting during the extension and retraction of the extendable box through fixed sliders one, two, three, and four.

5. According to claim 4, sliders one and two are vertically aligned, as are sliders three and four, and sliders one and three are in a straight line, parallel to sliders two and four.

6. According to claim 1, the ball screw drive assembly comprises a motor, motor bracket, small synchronous pulley, ball screw, nut flange, nut cover, bearing one, bearing two, nut flange sleeve, large synchronous pulley, synchronous belt, and nut mounting bracket. The motor is mounted on the upper plate via the motor bracket, with its output shaft connected to the small synchronous pulley. The ball screw passes through the nut flange, which has the large synchronous pulley attached. The small synchronous pulley and large synchronous pulley are synchronized via the synchronous belt. On either side of the nut flange, there are nut cover and nut sleeve, with bearings one and two ensuring the rotational movement of the nut flange. These components are secured to the support frame via the nut mounting bracket.

7. According to claim 6, the nut mounting bracket features bearing mounts one and two to stabilize bearings one and two.

8. According to claim 7, the load-bearing plate has screw rod mounting brackets one and two at each end, securing the ends of the ball screw to the load-bearing plate.

9. According to claim 6, the load-bearing plate, carrying box, and ball screw are parallel along their lengths.

10. According to claim 1, the carrying box has a removable inspection panel on the side facing the interior of the vehicle.
